(19) United States
(12) Patent Application Publication
(10) Pub. No.: US 2023/0251206 A1
(43) Pub. Date: Aug. 10, 2023

(54) SYSTEM AND METHOD TO DETERMINE A SCORE INDICATING SEAL INTEGRITY IN A PACKAGE

(71) Applicant: Greyscale AI, San Carlos, CA (US)

(72) Inventors: Richard John Cisek, San Francisco, CA (US); Wenbo Zhang, San Carlos, CA (US)

(21) Appl. No.: 17/668,284

(22) Filed: Feb. 9, 2022

(51) Int. Cl. G01N 21/90

(52) U.S. Cl. CPC G01N 21/9054; G01N 2021/8887

(57) ABSTRACT

The present disclosure relates to a system and method to measure the quality of the inspection process by assigning a score to indicate the level of integrity of a seal of a package in a packaged product. The packaged product is run through an inspection machine, e.g., an X-ray machine, to capture an image. Image processing techniques are used to identify the seal region from the image, which is then divided into a number of sub-regions. Seal scores for each sub-region is calculated using a mathematical framework that takes into account existence (or non-existence) of certain types of defects in the sub-regions. A report is generated to display the results of the seal score determination algorithm to the entity that requested the seal score.

### TECHNICAL FIELD

The present disclosure generally relates to automatically determining and assigning a score that indicates a level of integrity of a seal in a package irrespective of the shape of the package and the content inside the package.

### BACKGROUND

The automated inspection industry is a very large and diverse industry (with annual revenues exceeding 30 billion dollars). A subset of this industry is focused on inspection of food, beverage and/or pharmaceutical products. The product inspection industry offers machines that check primarily for proper product weight as well as for existence of undesired foreign material in the packaged product. For simplicity, this inspection segment will be referred to as “food inspection” in the specification, though other packaged products are also within the scope of this disclosure.

Historically, very large concentration of global market share in the food inspection industry has remained with a handful of companies that enjoy established distribution chain in protected markets and hence tend to focus and rely on traditional inspection techniques that do not reply on advanced digital tools.

The state of the art in the food inspection industry can be best described as point solutions that are largely incrementally improved solutions based on capabilities developed long ago. Most production lines merely include the ability to check product weight and a device for inspecting if a foreign material exists. This type of disaggregated capability (i.e. lack of the ability to prevent defects rather than just detect them on a production line) makes it very hard for operators to get an insightful perspective on the quality of the product being produced. Therefore, defective products (for example, products that have undesired foreign materials and/or have less material than what the specification says) are produced more often than operators would like and these defects add extra costs to the business. Worst yet, defects that are not discovered during production may show up as recalls, and the company's reputation can be at stake.

In addition to providing less than optimal production insight, current state of the art inspection equipment fails to address several use cases that are critical to measuring product quality, particularly the measurement of sealing quality and seal strength for sealed products.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

The present disclosure involves measuring the quality of the inspection process by assigning a score to indicate the level of integrity of a seal of a package. Note that though food is used as an illustrative example of what the package contains, the scope of this disclosure is not limited by what is inside the package. The scoring defines a complex process that distills a collection of data into a simple and easy-to-track metric, which is referred to as “seal score.”

The packaged product is run through an inspection machine, e.g., an X-ray or hyperspectral vision machine, to capture an image. Image processing techniques are used to identify the seal region from the image, which is then divided into a number of sub-regions. Seal scores for each sub-region are calculated using a mathematical framework that takes into account existence (or non-existence) of certain types of defects in the sub-regions. A report is generated to display the results of the seal score determination algorithm to the entity that requested the seal score.

### BRIEF DESCRIPTION OF THE DRAWINGS

The present disclosure will be understood more fully from the detailed description given below and from the accompanying drawings of various embodiments of the disclosure.

FIG. 1 shows a block diagram of the main components of production line quality control system, according to an embodiment of the present disclosure.

FIG. 2 is a flow diagram of the process to generate a seal score, according to an embodiment of the present disclosure.

FIG. 3 represents a schematic of a peripheral seal of an exemplary rectangular package containing food inside, wherein the peripheral seal is divided into distinct regions, according to an embodiment of the present disclosure.

FIG. 4A depicts a package having an arbitrary shape whose peripheral seal is divided into a collection of distinct regions, according to an embodiment of the present disclosure.

FIG. 4B depicts a package having an oval shape whose peripheral seal is a continuous region, according to an embodiment of the present disclosure.

FIG. 5 depicts an exemplary table showing calculated seal score distribution, according to an embodiment of the present disclosure.

FIG. 6 illustrates an exemplary user interface to display a calculated seal score, according to an embodiment of the present disclosure.

FIG. 7 illustrates an example machine of a computer system within which a set of instructions, for causing the machine to perform any one or more of the methodologies discussed herein, can be executed.

### DETAILED DESCRIPTION

As hardware capability has increased, software has and continues to be a greater share of the enabling capability for machines to inspect merchandise during production. The hardware and software in unison measure the quality of the production process. Embodiments of the present disclosure are directed to, as part of quality control, automatically generating a seal score upon inspecting the seal integrity of a package irrespective of the shape and/or the content of the package. Though this seal score is described as a useful quality indicator during the production phase, the scope of the disclosure encompasses a distribution phase as well.

To leverage the quality control capabilities, it is important to think about inspection solutions as networks of machines that may be connected by a cloud platform that controls the machines, aggregates the data produced by them and then is capable of doing post processing on the inspection data to produce distilled insights, for example, producing a seal score. Using the food, beverage or pharmaceutical production line as an example, conceptually the quality control sequence can be divided into three stages: raw materials come to the plant, product is made, and product is packaged. The approach disclosed herein allows for real time quality assurance at each of these stages, and possibly across multiple production lines.

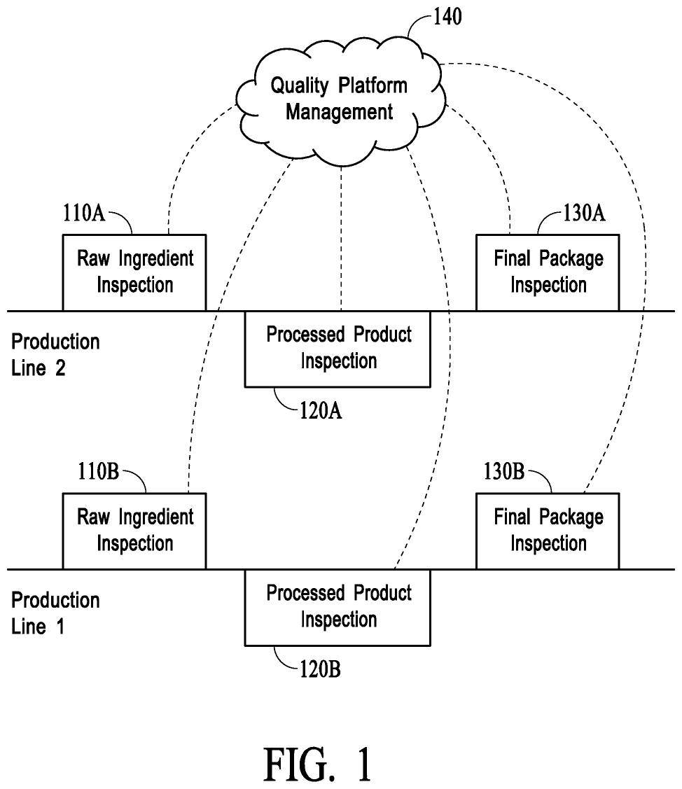

FIG. 1 shows two production lines (production line 1 and production line 2), each having three stages of inspection: raw ingredient inspection (110A and 110B), processed product inspection (120A and 120B) before packaging, and final package inspection (130A and 130B), i.e. after the processed product is sealed and packaged. Though two production lines are shown as an illustrative example, any non-zero number of production lines would be within the scope of this disclosure.

All the inspection devices are communicatively coupled with a Quality Management Platform 140—the dashed lines indicating communicative coupling. The platform 140 may reside in a server in a cloud, though in some embodiments the platform 140 may reside in a local network. The platform 140 receives inspection data from the various inspection devices (e.g., 110A-B, 120A-B, and 130A-B)

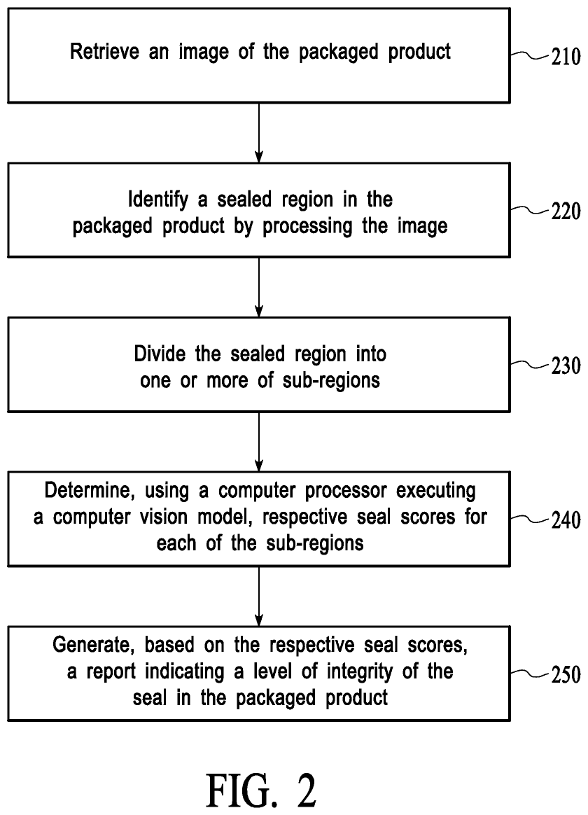

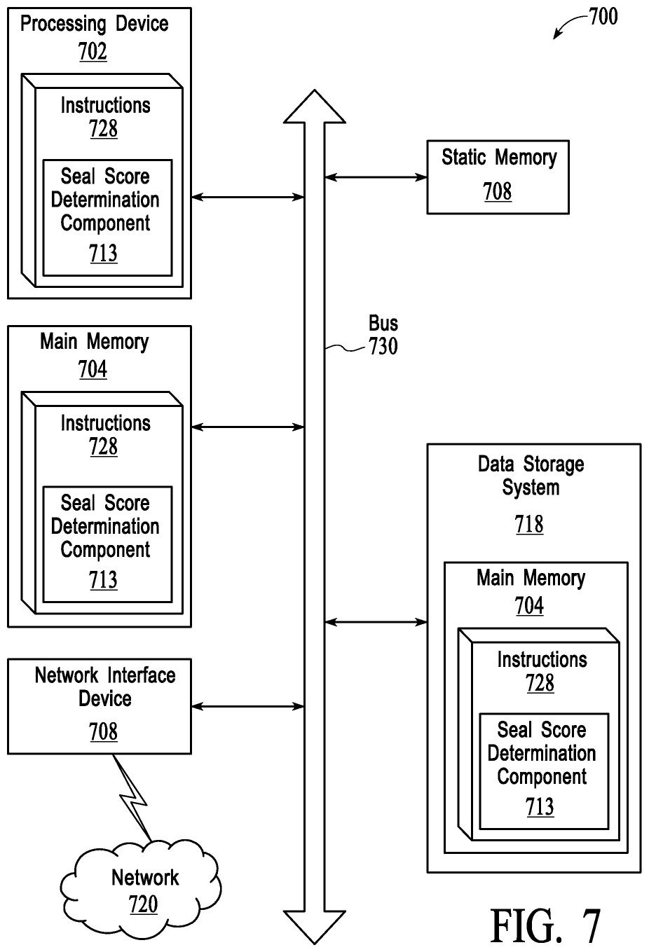

FIG. 2 is a flow diagram of an example high-level method 200 of automatic seal score generation as implemented by a component operating in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the seal score determination component 713 shown in FIG. 7. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At operation 210, an image of a packaged product is retrieved. This image retrieval operation can be triggered automatically/semi-automatically/manually upon receiving a request for a seal score report (explained below) from a company. Alternatively, this operation can be performed as a quality control measure in one or more production lines. The image may be retrieved by running packaged products through an X-ray or hyperspectral vision machine or other image capturing devices. If more than one production lines are involved, a seal score report can be generated selectively from any of the lines. A sampling interval may be set to generate seal score reports from selected packaged products. Sampling can be random or deterministic along a selected production line and can jump from one production line to another.

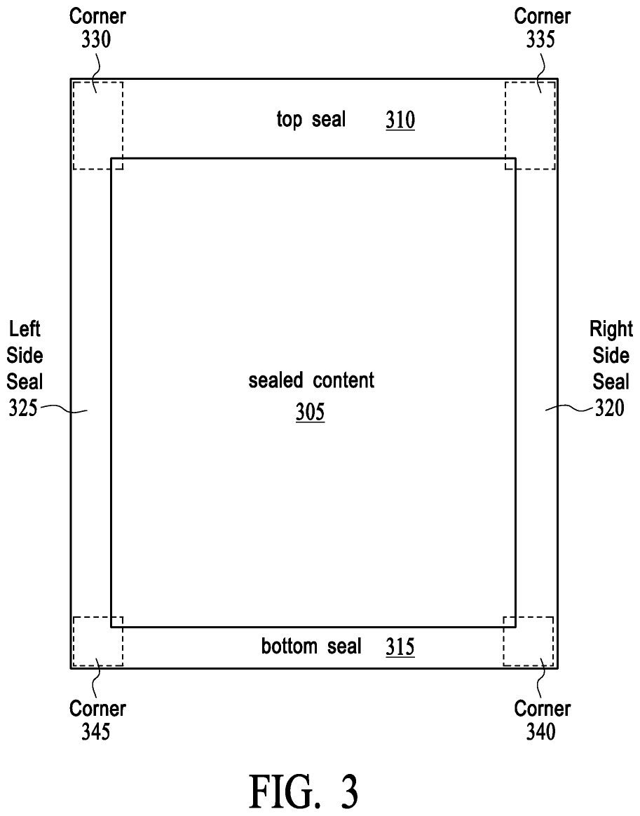

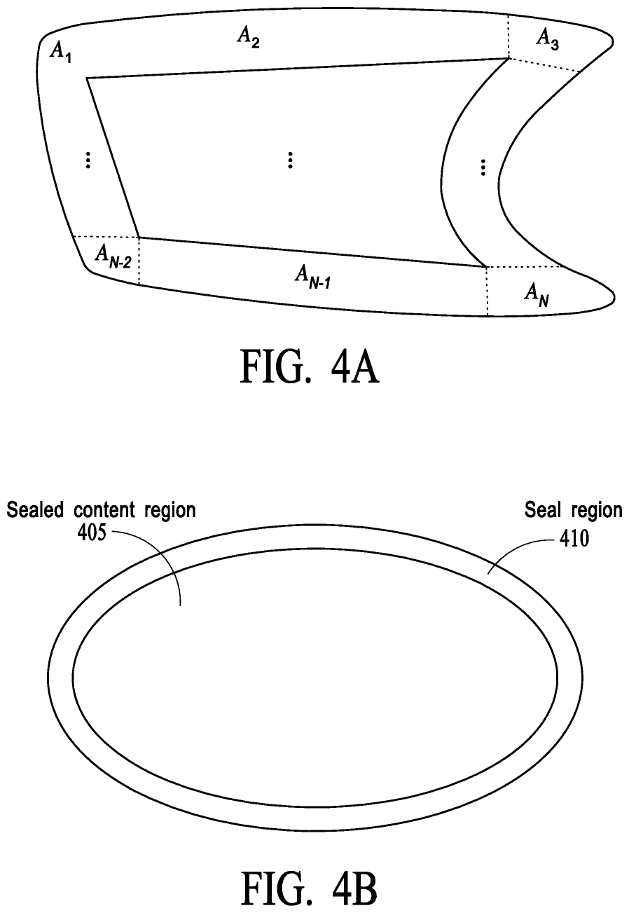

At operation 220, a sealed region is identified from the retrieved image of the packaged product using image processing techniques. The sealed region can be along the periphery of the packaged product, as shown in FIGS. 3, 4A and 4B, with the sealed content region in the center. Though not shown in the figures, the sealed region does not have to be along the periphery only. For example, a sealed product can have multiple sealed compartments.

At operation 230, the identified sealed region is divided into one or more sub-regions. For example, in FIG. 3, the sub-regions are top seal, bottom seal, right side seal, left side seal, and the four corners shown within the dashed outlines.

At operation 240, a computer processor executes a computer vision model, to determine respective seal scores for the one or more sub-regions. This computer vision model could be any model that takes an image of a product as input and returns output data that can be used to make decisions about the product. An example mathematical framework for a possible computer vision model to address this problem is described in further details below, but there are many other possible approaches.

At operation 250, a report can be generated based on the respective seal scores. The report can take many forms, but the general idea is that the report is an indicator of a level of integrity of the seal in the packaged product. That way, the report facilitates in overall quality control. The report can help discarding defective products from appearing into the distribution chain. The report can also serve as a guide to correct the packaging process if seal scores do not meet certain threshold criteria set to certify the seal to have a desired level of integrity.

FIG. 3 shows an illustrative packaged product (sometimes referred to as a “pouch”) in the shape of a rectangle, where the sealed content is at the center surrounded by a peripheral sealed region. This package is used to convey the concept of the mathematical framework used in the computer vision model to generate seal score for different sub-regions. The framework is then extended to cover packages of any arbitrary shape, including a special example (an oval pouch shown in FIG. 4B) where all the sub-regions are merged into just one continuous sealed region.

Specifically, in FIG. 3, the sub-regions are: top seal 310, right side seal 320, bottom seal 315, left side seal 325, top right corner 335, bottom right corner 340, bottom left corner 345 and top left corner 330, which collectively surrounding the sealed content region 305.

In this example, mathematically, the area for each sub-region is defined as A_{region}, where, the set region contains {top, bottom, side, corner, content}. Assuming there are five sub-regions, then the total region

$${𝒜}_{total} = {𝒜}_{top} + {𝒜}_{bottom} + {𝒜}_{side} + {𝒜}_{corner} + {𝒜}_{content} \qquad Equation ( 1 )$$

The score percent of each region could be defined as S_{region}, where,

$${𝒮}_{region} = {𝒜}_{region} / {𝒜}_{total}$$

Thus, the equation could be formulated as

$${𝒮}_{top} + {𝒮}_{bottom} + {𝒮}_{side} + {𝒮}_{corner} + {𝒮}_{content} = 1 \qquad Equation ( 2 )$$

The Side Seal includes Left Side Seal (325) and Right Side Seal (320). The Corner Seal includes Top Corner Seals (330 and 335) and Bottom Corner Seals (340 and 345). Thus, we define

$${𝒮}_{side} = {𝒮}_{left side} + {𝒮}_{right side} \qquad Equation ( 3 )$$

$$and$$

$${𝒮}_{corner} = {𝒮}_{top corner} + {𝒮}_{bottom corner} \qquad Equation ( 4 )$$

In each sub-region, there can be a variety of defects. As an illustrative example, four types of defects are considered, namely, Product In Seal (PIS) (alternatively Product in Seam), Micro-leak, Seal Width, and Foreign Material. The respective weight percentages for each type of defect is defined as D_{type}, where the set type contains {product, microleak, width, foreign}. Therefore, the equation for the defect types is formulated as

$${𝒟}_{product} + {𝒟}_{microleak} + {𝒟}_{width} + {𝒟}_{foreign} = 1. \qquad Equation ( 5 )$$

The Micro-leak defect type includes Fatal Micro-leak and Non-fatal Micro-leak. So we can formulate the Micro-leak defect as,

$${𝒟}_{microleak} = {𝒟}_{fatal microleak} + {𝒟}_{non - fatal microleak} . \qquad Equation ( 6 )$$

An indicator function I is defined as

$$I [ region ∈ {𝒳}_{type}^{good} ] = \{ \begin{matrix}1 & if this defect type does not exist in region , \\ 0 & otherwise\end{matrix} .$$

where the set X denotes the seal region without a particular type of defect.

In this example, the quantitative value of the Seal Score is defined as

$${Q}_{score} ∈ [ 0 , 100 ]$$

Q is in the range between 0 and 100, where a value of 100 indicates there is not any defect in any of the seal sub-regions, and a value of 0 indicates every type of defect exists in all the sub-regions. Based on the defect region and type, the Seal Score is defined as

$${Q}_{score} = 100 \times {\sum }_{region} {\sum }_{type} {𝒮}_{region} \cdot {𝒟}_{type} I [ region ∈ {𝒳}_{type}^{good} ] \qquad Equation ( 7 )$$

In other iterations, the seal score does not have to be based on indicator functions, and the score for a certain region could be a continuous function based on the determined quality of the seal in that region, for instance.

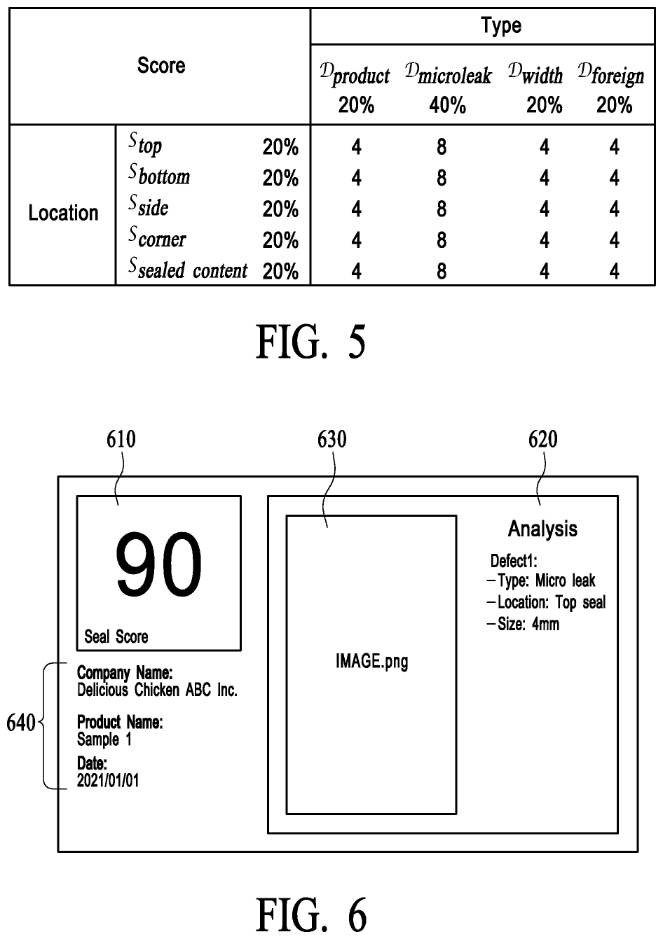

The Table in FIG. 5 shows example values of the Seal Score for different regions and different types of defects, as calculated by the equation (7). In this example, all physical locations of the package are equally weighted in terms of their impact on the seal score. Microleaks have the highest defect weighting whereas all other defect types (e.g., product-in-seal (PIS), foreign material in seal and seal width) are equally weighted.

As mentioned above, the mathematical framework shown using a rectangular pouch can be extended to a more general framework for packed products with an arbitrary shape. For example, FIG. 4A shows a random shaped packaged product with a peripheral seal surrounding sealed content region at the center.

Just like the rectangular pouch, for the packaged product shown in FIG. 4A, the seal region can be divided into a plurality of sub-regions denoted as Aᵢ, where i−1, . . . N.

Therefore the total area is:

$$𝒜 \text{?} i = {𝒜}_{1} + + {𝒜}_{N} = {\sum }_{i = 1}^{N} {𝒜}_{i} \qquad Equation ( 8 )$$

$$\text{?} \text{indicates text missing or illegible when filed}$$

The area fraction for each region is:

$${𝒮}_{i} = {??}_{i} / {𝒜}_{total} . \qquad Equation ( 9 )$$

For different defect types Dⱼ (where j=1, . . . , M), the indicator function is:

$$I [ {𝒜}_{i} ∈ {𝒳}_{j}^{good} ] = \{ \begin{matrix}1 & if this defect type j does not exist in region {𝒜}_{i} , \\ 0 & otherwise\end{matrix} .$$

where the set X denotes the seal region without a j type of defect.

The quantitative value of the Seal Score is defined as

$${Q}_{score} = 100 \times {\sum }_{i = 1}^{N} {\sum }_{j = 1}^{M} {𝒮}_{i} \cdot {𝒟}_{j} \cdot I [ {𝒜}_{i} ∈ {𝒳}_{j}^{good} ] . \qquad Equation ( 10 )$$

A specific example illustrating an application of the general framework is an oval shaped pouch shown in FIG. 4B, where the sealed content region 405 in the center is surrounded by a peripheral seal region 410, which is a continuous region, i.e. an area that does not need to be divided into sub-regions, then the Seal Score is:

$${Q}_{score} = 100 \times ( {\sum }_{j = 1}^{M} {𝒮}_{content} \cdot {𝒟}_{j} \cdot I [ {𝒜}_{content} ∈ {𝒳}_{j}^{good} ] + {\sum }_{j = 1}^{M} {𝒮}_{seal} \cdot {𝒟}_{j} \cdot I [ {𝒜}_{seal} ∈ {𝒳}_{j}^{good} ] )$$

If there is only Product in Seam (PIS) type defect in the seal region, then the seal score can be even simpler as:

$${Q}_{score} = 100 \times ( {𝒮}_{content} \cdot {𝒟}_{PIS} \cdot I [ {𝒜}_{content} ∈ {𝒳}_{PIS}^{good} ] + {𝒮}_{seal} \cdot {𝒟}_{PIS} \cdot I [ {𝒜}_{seal} ∈ {𝒳}_{PIS}^{good} ] )$$

FIG. 6 indicates an example of a user interface (UI) for a seal score report. In this example, the seal score may be displayed in an assigned area 610. There may be another assigned area 630 to display the image of the packaged product or a part thereof whose seal score is being displayed. Another area 620 may be assigned to display the findings of the mathematical analysis that leads to generating the seal score. For example, the “analysis” area may display a type of defect (e.g., micro-leak), a location of the defect (e.g., top seal) and a size of the defect at the top seal (e.g., 4 mm). Another area 640 may be assigned to display particulars of the product being inspected. For example, the company name, the product name or sample number, and date of inspection. These are only a few fields that are specifically mentioned as display items. Persons skilled in the art would understand that what information needs to be displayed can be customized in the UI. For example, the seal score for individual sub-regions can be displayed or an overall score can be displayed indicating whether the packaged product is defective and hence may be discarded from further distribution. In general, the seal score is utilized as a quality control measure, and a predetermined quality threshold can be input in the inspection system. If the seal score indicated satisfies the quality threshold, the product is cleared for distribution.

FIG. 7 illustrates an example machine of a computer system 700 within which a set of instructions, for causing the machine to perform any one or more of the methodologies discussed herein, can be executed. In some embodiments, the computer system 700 can correspond to a host system that includes, is coupled to, or utilizes a memory sub-system or can be used to perform the operations of a processor (e.g., to execute an operating system to perform operations corresponding to automatic information extraction, also referred to as seal score determination component 713). Note that the seal score determination component 713 may have sub-components, for example, text-cluster detection sub-component (this can also have a neighboring boxes merging decision-making component), OCR sub-component, text classification sub-component, question-answering model component, rule-based filter component and an output presentation component. In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 708 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 728 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 728 or software embodying any one or more of the methodologies or functions described herein. The instructions 728 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to a memory sub-system.

In one embodiment, the instructions 728 include instructions to implement functionality corresponding to the seal score determination component 713. While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A computer-implemented method for inspecting integrity of seal in a packaged product, the method comprising:
retrieving an image of the packaged product;
identifying a sealed region in the packaged product via image processing;
dividing the sealed region into one or more sub-regions;
determining, using a computer processor executing a computer vision model, respective seal scores for each of the sub-regions; and
generating, based on the respective seal scores, a report indicating a level of integrity of the seal in the packaged product.

2. The method of claim 1, further comprising:
prior to retrieving the image of the packaged product,
receiving a request, from an entity associated with the packaged product, to generate a report on the level of integrity of the seal in the packaged product.

3. The method of claim 2, further comprising:
upon receiving the request, passing the packaged product through an inspection machine that captures the image of the packaged product that is retrieved for image processing.

4. The method of claim 3, wherein the inspection machine comprises an X-ray machine, a hyperspectral vision machine or other imaging tool.

5. The method of claim 1, wherein the one or more sub-regions are disposed along a peripheral seal of the packaged product.

6. The method of claim 5, wherein the packaged product contains sealed content encompassed by the peripheral seal.

7. The method of claim 1, wherein the report indicates a type of defect.

8. The method of claim 7, wherein the type of defect comprises one or more of: a defect related to a product-in-seal (PIS), defect related to a micro-leak, defect related to a width of seal, and a defect related to existence of foreign material.

9. The method of claim 8, wherein determining the seal score includes defining an indicator function that outputs “1” if a particular type of defect does not exist in a particular sub-region, and outputs “0” if a particular type of defect does exist in a particular sub-region.

10. The method of claim 1, wherein a user interface displays respective seal scores for the sub-regions.

11. The method of claim 10, wherein the user interface displays the one or more types of defect found in a particular sub-region.

12. The method of claim 10, wherein the user interface displays an image of the particular sub-region whose seal score is being displayed.

13. A system for inspecting integrity of seal in a packaged product, where a computer processor performs the operations of:
retrieving an image of the packaged product;
identifying a sealed region in the packaged product via image processing;
dividing the sealed region into one or more of sub-regions;
determining, using a computer processor executing a computer vision model, respective seal scores for each of the sub-regions; and
generating, based on the respective seal scores, a report indicating a level of integrity of the seal in the packaged product.

14. The system of claim 13, wherein prior to retrieving the image of the packaged product, the computer processor receives a request, from an entity associated with the packaged product, to generate a report on the level of integrity of the seal in the packaged product.

15. The system of claim 14, wherein upon receiving the request, the packaged product is passed through an inspection machine that captures the image of the packaged product that is retrieved for image processing.

16. The system of claim 13, wherein the one or more sub-regions are disposed along a peripheral seal of the packaged product.

17. The system of claim 16, wherein the packaged product contains sealed content encompassed by the peripheral seal.

18. The system of claim 13, wherein the report indicates a type of defect.

19. The system of claim 18, wherein determining the seal score includes defining an indicator function that outputs “1” if a particular type of defect does not exist in a particular sub-region, and outputs “0” if a particular type of defect does exist in a particular sub-region.

20. The system of claim 13, wherein a user interface displays respective seal scores for the sub-regions.
